(19) United States
(12) Patent Application Publication
(10) Pub. No.: US 2019/0159961 A1
(43) Pub. Date: May 30, 2019

(54) Massage device

(71) Applicant: Jaguar Precision Industry Co., Ltd., New Taipei City (TW)

(72) Inventor: Fei-Tyh Chuang, New Taipei City (TW)

(21) Appl. No.: 16/192,947

(22) Filed: Nov. 16, 2018

(30) Foreign Application Priority Data
Nov. 27, 2017 (TW) 106141197

(51) Int. Cl. A61H 23/02; A61H 23/00

(52) U.S. Cl. CPC A61H 23/0218; A61H 2201/0153; A61H 2201/123; A61H 23/006

(57) ABSTRACT

A massage device comprising an output shaft, a plurality of permanent magnets arranged on the output shaft, and an electromagnetic driving module arranged radially outside the permanent magnets. The stator yoke of the electromagnetic driving module and the permanent magnets interact to generate a cogging torque. The electromagnetic driving module interacts with the permanent magnets to generate an electromagnetic driving force. The massage device has improvements in efficiency and output, is compact and reduces heat generation. The activation of the electromagnetic driving module actuates the output shaft to strike forward. The cogging torque applies a first pulling force to the output shaft to provide braking and buffering to the output shaft. When the output shaft is urged to move in the direction opposite to the strike forward direction from the idle state, the cogging torque applies a first thrust to the output shaft, to thereby increase the output.

### BACKGROUND OF THE INVENTION

### 1. Field of the Invention

The present invention relates to a massage device, and in particular to a massage device capable of massaging human muscles, acupressure meridians, acupuncture points or specific trigger points, or in particular to an impact vibration device for human bones.

### 2. Description of the Related Art

There are various massage devices on the market that meet various requirements. For example, a massage chair may massage the entire back and neck, a foot massage device may perform the massage of the calf, and even the entire foot plate, and the massage gun can perform massaging by targeting on specific acupuncture points or specific trigger points.

Some related art of the massage gun includes Taiwan Utility Model Patent Publication Nos. M343481, M446632, M508318, and Taiwan Invention Patent Publication No. 201440753 in which M343481 uses a motor to drive the crankshaft to achieve a reciprocating impact function. However, the impact effect of the crankshaft is not obvious, and the output force is not a linear output, as the reciprocating action generated by the crank mechanism will be somewhat swaying, and the recoil force is great when the crankshaft restores its position. In addition, the crank mechanism consumes a large space, and the vibration frequency and impact force cannot be independently controlled.

As to M446632, M508318, and 201440753, the three patent documents make use a solenoid valve to drive the output shaft to propel the same in a single direction (the direction towards the massaging target), and then make use of the spring to retract the output shaft to its original position, to thereby repeatedly applying pressure to the muscles or acupuncture points. These inventions avoids the disadvantages of using the crankshaft as mentioned above, and the vibration frequency and impact force can be independently controlled.

In these three inventions, the output relies on the output shaft and the electromagnetic force of the solenoid valve coil. As the operation of the output shaft is effected only by electromagnet and permanent magnet is not used, the efficiency is poor, and heat is easily generated. Further, the end of the output stroke of the output shaft must be buffered by a spring, and a spring must also be used to restore the output shaft to its position. However, the springs will inevitably consume a portion of the output force, results in energy consumption. Further, the spring will have the problem of life span and noise, and increase the complexity of the structure.

### SUMMARY OF THE INVENTION

The main object of the present invention is to provide a massage device that uses permanent magnets to improve the efficiency of an electromagnetic actuator, so that cogging torque can be used to restore to original position, and to facilitate positioning at idle state. Further, the cogging torque may generate cushioning force to reduce the noise. The present invention is advantageous in that it is compact, powerful, and does not generate heat in addition, the dogging torque may increase the output, to improve the massage force.

In order to achieve the above object, a massage device according to the present invention comprises an output shaft, a plurality of permanent magnets and an electromagnetic driving module. The plurality of permanent magnets are disposed on the output shaft, and generates a radial magnetic field on a partial region of the output shaft. The electromagnetic driving module comprises at least a stator yoke and at least one coil, and the electromagnetic driving module is disposed radially outside the plurality of permanent magnets of the output shaft. At least one stator yoke of the electromagnetic driving module interacts with a magnetic field of the plurality of permanent magnets of the output shaft to generate a cogging torque, and at least one coil of the electromagnetic driving module is driven by a current to generate an electromagnetic field which interacts with the radial magnetic field of the plurality of permanent magnets to generate an electromagnetic driving force.

When deactivated, the output shaft stops in the region where the resultant force of the cogging torque and the frictional force is zero. When the electromagnetic driving module is energized, the output shaft is actuated to strike forward in the axial direction. At this instant, the cogging torque applies a first pulling force to the output shaft, so as to provide the output shaft with braking and buffering functions. When the electromagnetic driving module is deenergized, the output shaft is actuated to return to the region where the resultant force of the cogging torque and the friction force along the axial direction is zero, and a buffer spring is not needed. As such, noise is reduced the reliability and compactness of the device are improved. When the output shaft is urged to move in the direction opposite to the strike forward direction, the cogging torque applies the first thrust to the output shaft, and output is increased.

Preferably, the cogging torque applies a first thrust to the output shaft before the intermediate point of an output stroke, and the cogging torque starts to reverse after the intermediate point of the output stroke, and applies a first pulling force to the output shaft. In other words, when at least one coil of the electromagnetic driving module is initially driven by the current, the output shaft strikes forward in the axial direction. The cogging torque applies a first pulling to the output shaft after the intermediate point of the output stroke, and when the current supply is interrupted, the cogging torque pulls the output shaft to return to a rest position. When the output shaft is urged to move in the direction opposite to the strike forward direction and pass the rest position, the cogging torque applies a first thrust to the output shaft.

Accordingly, the massage device according to the present invention may make full use of the cogging torque. When the output shaft is urged to move in the direction opposite to the strike forward from the idle state, the cogging torque applies the first thrust to the output shaft to increase the output. In addition, a first pulling force is applied to the output shaft in the rear stage of the output stroke to generate braking and buffering effects on the output shaft to reduce noise. That is, the first pulling force generated by the cogging torque after the striking will return the output shaft to the rest position to prepare for the next strike.

The massage device according to the present invention may further comprise at least one magnetically permeable member disposed on the output shaft, and interacting with the plurality of permanent magnets and the electromagnetic driving module; wherein the magnetically permeable member is disposed on the output shaft and is located between the plural permanent magnets. In addition, the massage device according to the present invention may further include a control module, and the electromagnetic driving module is electrically connected to the control module. The control module can adjust the magnitude of the electromagnetic driving force by controlling the magnitude of the current input to the electromagnetic driving module. Moreover, the control module can adjust the length of the output stroke by controlling the duration of the current input to the electromagnetic driving module. The control module can also adjust the period or cycle of the output stroke by controlling the period or frequency of the current input to the electromagnetic driving module.

In addition, the massage device of the present invention may further include an adjustment module that is electrically connected to the control module and adapted to adjust at least one of the magnitude, frequency, and duration of the current input to the electromagnetic driving module. In addition, the massage device of the present invention may further include at least one position detector that is electrically connected to the control module and adapted to detect the output shaft.

In addition, the electromagnetic driving module of the massage device according to the present invention may further include an annular coil holder and a coil which is wound around the annular coil holder, and electrically connected to the control module. The coil holder may include a central through hole through which the output shaft extends.

Preferably, the massage device according to the present invention further comprises a massage head and an impact magnetic set. The massage head corresponds to one end of the output shaft, and the impact magnetic set is disposed between the massage head and the output shaft. The impact magnetic set includes two separated impact magnets arranged adjacent to each other, in which the opposing ends of the two separated impact magnets have the same polarity, to thereby generate a repulsive force that renders the output shaft to exert an impact force on the massage head. Accordingly, in the present invention, the two adjacent impact magnets are designed to have the same polarity in magnetic property so as to produce a repulsive force that is inversely proportional to the square of the distance. As such, not only an instantaneous impact effect is formed, but the instantaneous impact force also has a cushioning characteristic to avoid the noise and discomfort produced due to direct collision of the mechanical components.

Moreover, the massage device of the present invention may include a position detector that is electrically connected to the control module and for detecting the stroke position of the massage head. Further, the control module according to the present invention includes a storage unit configured to store at least one application for controlling at least one of the magnitude, frequency and duration of the current input to the electromagnetic driving module. In other words, the magnitude, frequency and duration of the current input to the electromagnetic driving module are variable by setting the parameters of the application. That is, the application can set the magnitude of the electromagnetic driving force, the periodic frequency of the output stroke, and the length of the output stroke.

### BRIEF DESCRIPTION OF THE DRAWINGS

FIG. 1 is an exploded view of a preferred embodiment of a massage device according to the present invention.

FIG. 2 is a cross-sectional view of a preferred embodiment of the present invention.

FIG. 3 is a schematic illustration of the massage device according to the present invention showing the location of the output shaft and the relationship between the output of the output shaft and the cogging torque.

FIGS. 4A to 4I schematically illustrate changes in magnetic intensity of the electromagnetic driving forces at various positions when a current is applied to the electromagnetic driving module by a preferred embodiment of the present invention.

FIGS. 5A to 5I schematically illustrate changes in magnetic intensity of the cogging torque at various positions when a current is applied to the electromagnetic driving module by a preferred embodiment of the present invention.

FIG. 6A is a cross-sectional view showing another preferred embodiment of the present invention at the idle state.

FIG. 6B is a cross-sectional view of the massage head of another preferred embodiment of the present invention after being pushed.

FIG. 6C is a cross-sectional view of the output shaft of another preferred embodiment of the present invention after striking.

### DESCRIPTION OF THE PREFERRED EMBODIMENTS

The present invention is related to a massage device. In the descriptions, similar elements will be denoted by the same reference numerals. Moreover, the drawings illustrating the present invention are only schematic and not necessarily drawn to scale, and may not show all details thereof.

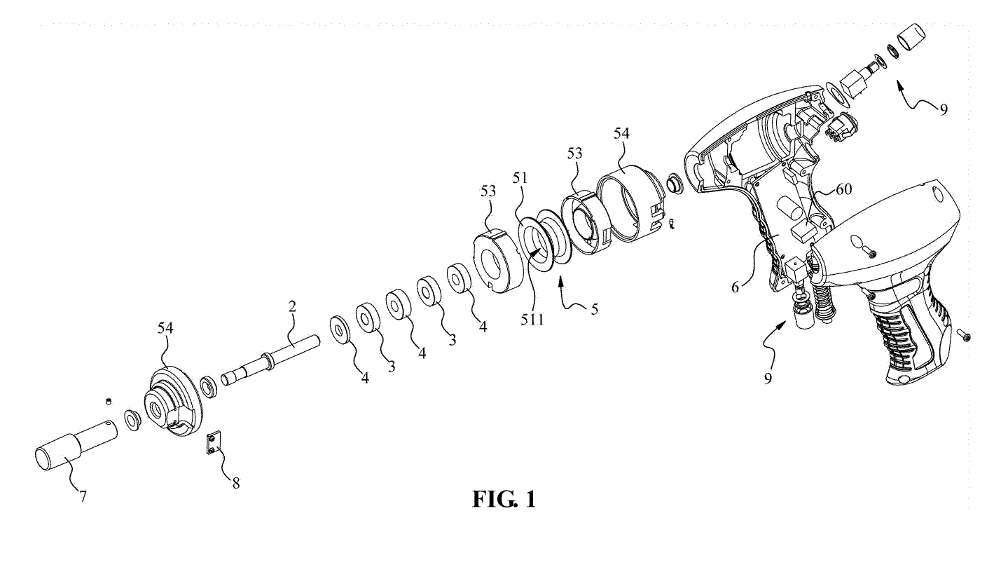

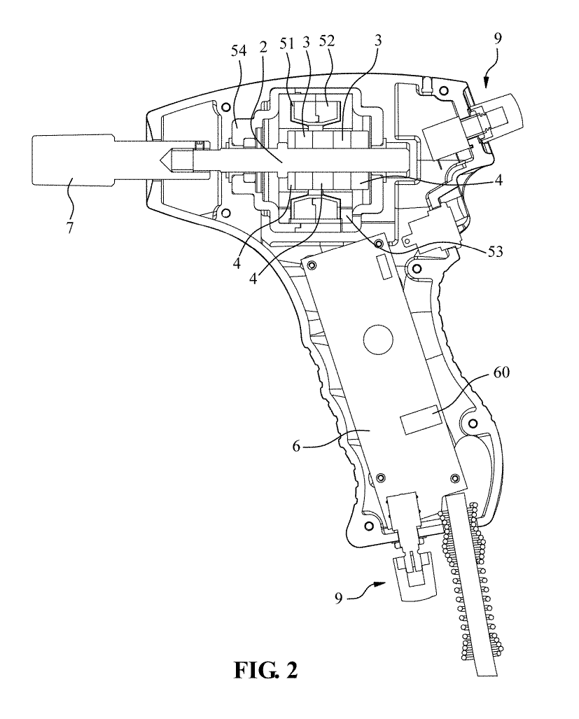

Referring to FIGS. 1 and 2, in which FIG. 1 is an exploded view of a preferred embodiment of the massage device according to the present invention, and FIG. 2 is a cross-sectional view of a preferred embodiment of the massage device of the present invention. As shown in the figures, the massage device of this embodiment mainly comprises an output shaft 2, two permanent magnets 3, three magnetically permeable members 4, an electromagnetic driving module 5, a control module 6, a massage head 7, a position detector 8 and an adjustment module 9. The permanent magnets 3 and the magnetically permeable members 4 are disposed on the output shaft 2. One of the permanent magnets 3 has one end arranged adjacent to one end of the other of the permanent magnets 3, in which the two ends adjacent to each other have the same polarity. The three magnetically permeable members 4 are arranged in such a manner that one is located between the two permanent magnets 3, one in front and one at the back of the permanent magnet. Furthermore, the electromagnetic driving module 5 is disposed radially outside the permanent magnets 3.

In this embodiment, the electromagnetic driving module 5 includes an annular coil holder 51, a coil 52 and a stator yoke 53. The coil 52 is wound around the annular coil holder 51. The coil holder 51 includes a central through hole 511 through which the output shaft 2, the permanent magnet 3 and the magnetically permeable member 4 extend and move axially (to be explained hereinafter). Further, as shown in the figure, the stator yoke 53 may retain the annular coil holder 51, and guide the magnetic field of the permanent magnets 3 to interact with the current flowing in the coil to generate electromagnetic force. Also shown is a motor housing 54 that is structured to accommodate and retain the permanent magnet 3, the magnetically permeable member 4, the stator yoke 53, and a portion of the output shaft 2.

On the other hand the massage head 7 for directly contacting the skin of the user is disposed on the output shaft 2. In this embodiment, the massage head 7 is detachable, and thus can be replaced with one in different form to cope with the circumstances. For example, a massage head 7 having an acute angle at the head end is preferred for massaging deep-layered muscles or acupuncture points, while a massage head 7 in the shape of a disc is preferred for massaging an extensive, shallow layered muscles of large area. In addition, a position detector 8 is disposed on the motor housing 54 for detecting the stroke of the output shaft 2.

As shown in the drawings, the control module 6 designed to control various functions of the massage device comprises a processor, a storage unit 60, a circuit board, and other electronic components. The adjustment module 9 is designed for the user to operate, adjust, and set various functions, such as the magnitude of the massage force, the distance of the massage stroke, and the speed frequency. The adjustment module 9, the position detector 8 and the electromagnetic driving module 5 are electrically connected to the control module 6. The storage unit 60 stores therein a plurality of applications to actuate different operation modes. The applications may set different current frequencies, different current magnitudes, and different timing and period input of the current for the electromagnetic driving module, so that the output shaft 2 may operate at different modes.

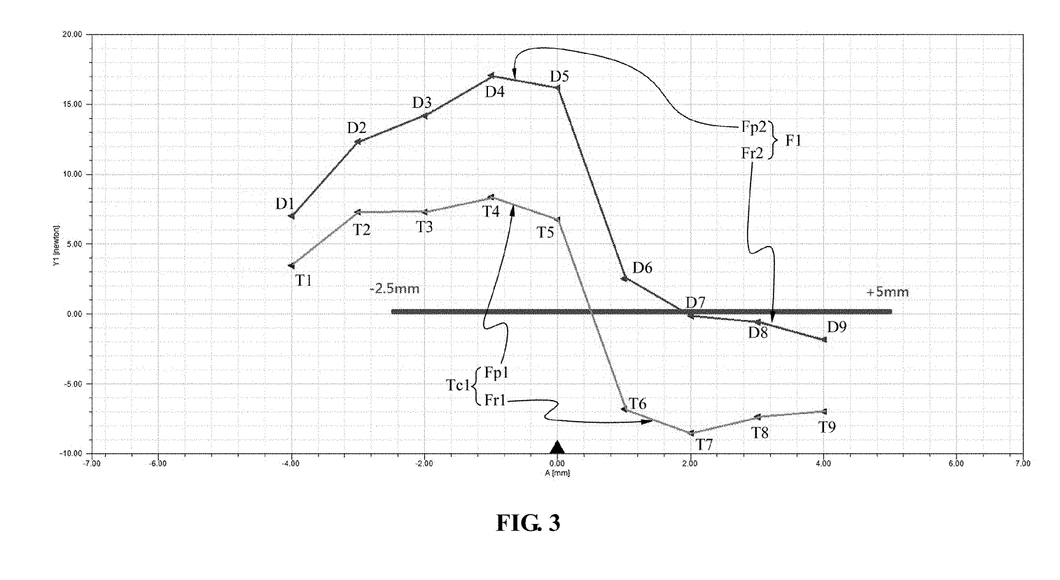

FIG. 3 shows the relationship between the position of the output shaft 2, the output F1 of the output shaft 2, and the cogging torque Tc1 of the massage device according to a preferred embodiment of the present invention. In this preferred embodiment, the output F1 of the output shaft 2 (that is, the resultant force of the electromagnetic driving force and the cogging torque) is variable depending on the magnitude of the current of the electromagnetic driving module 5. However, this embodiment is merely illustrative, and the present invention shall not be limited thereto. As shown in the figure, when the coil 3 of the electromagnetic driving module 5 is driven by a current, an electromagnetic field is generated, and the electromagnetic field will interact with the magnetic field of the permanent magnet 3 to generate an electromagnetic driving force. In addition, the slotting of the stator yoke 53 in the electromagnetic driving module 5 results in generating a cogging torque Tc1 with the permanent magnet 3. The resultant force of the electromagnetic driving force and the cogging torque Tc1 constitutes the output F1 of the output shaft as shown in FIG. 2.

As shown in FIG. 3, in the present embodiment, before an intermediate point of an output stroke, that is, the intermediate position between D5 and T5, both the output F1 of the output shaft 2 and the cogging torque Tc1 apply a codirectional thrust onto the output shaft 2, so that the output shaft 2 is axially pushed outwards. Here, the force applied by the cogging torque Tc1 is the first thrust force Fp1, and the output of the output shaft 2 is the second thrust force Fp2.

Then, the cogging torque Tc1 begins to reverse after the intermediate point (T5) of the output stroke, and descends abruptly to become a reverse pulling force. In other words, the cogging torque Tc1 turns abruptly from the first thrust Fp1 to the first pulling force Fr1. On the other hand, the output F1 of the output shaft 2 also reverses after the intermediate point (D5) of the output stroke following the reversal of the cogging torque Tc1. However, after three quarters of the output stroke, that is, after D7, the output F1 of the output shaft 2 is converted into a pulling force, that is the second pulling force Fr2 as shown in the figure, because the electromagnetic driving force is less than the cogging torque Tc1.

However, it should be noted that the operation stroke between D7 and D9 is an abnormal working state. Generally speaking, a normal massage operation stroke will not this section of actuation stroke (to be explained hereinafter), and the electromagnetic driving module 5 will not be energized during this stroke. Furthermore, as the current input to the electromagnetic driving module 5 increases, the position where the electromagnetic driving force is smaller than the cogging torque Tc1 (i.e., the position of D7) will shift to the right correspondingly, so as to increase the operation stroke of the massage. In other words, the magnitude of the current input not only affects the magnitude of the electromagnetic driving force, but also affects the operation stroke.

The function and effect of the cogging torque Te1 are as explained below. When deactivated, the output shaft 2 stops in the region where the resultant force of the cogging torque Tc1 and the frictional force is zero, which is about in the region between T5 and T6. However, when the electromagnetic driving module 5 is energized, the output shaft 2 is actuated to strike forward in the axial direction, and the cogging torque Tc1 applies a first pulling force Fr1 to the output shaft 2, so as to provide the output shaft 2 with braking and buffering functions. When the electromagnetic driving module 5 is deenergized, the output shaft 2 may return to the region where the resultant force of the cogging torque Te1 and the friction force along the axial direction is zero, without the need for a buffer spring. As such, noise is reduced the reliability and compactness of the device are improved. When the output shall 2 is urged to move in the direction opposite to the strike forward direction from the idle state, the cogging torque T1 applies the first thrust Fp1 to the output shall 2, so that the output is increased.

Accordingly, to operate the massage device, the user operates to urge the massage head 7 against the user's skin, and places the output shaft 2 at the initial position of the output stroke, that is, in proximity to D4 and T4. Then, the electromagnetic driving module 5 is driven by the current to perform the entire output stroke, that is, from D4 to D6 and from T4 to T6. After the output stroke is completed, since the user still urges the massage head 7 against the user's skin, and due to the first pulling force Fr1 provided by the cogging torque Te1, the output shall 2 will quickly return to the initial position, and the cycle is repeated.

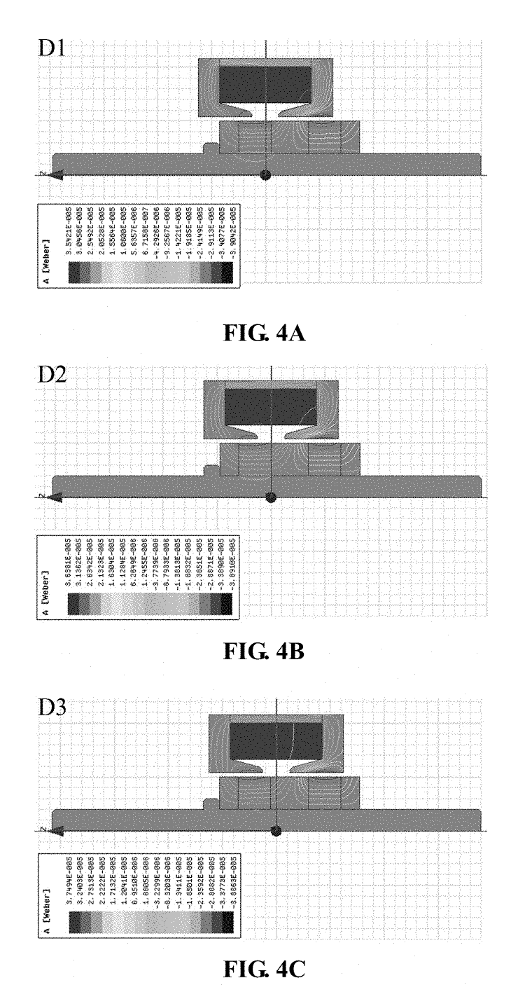

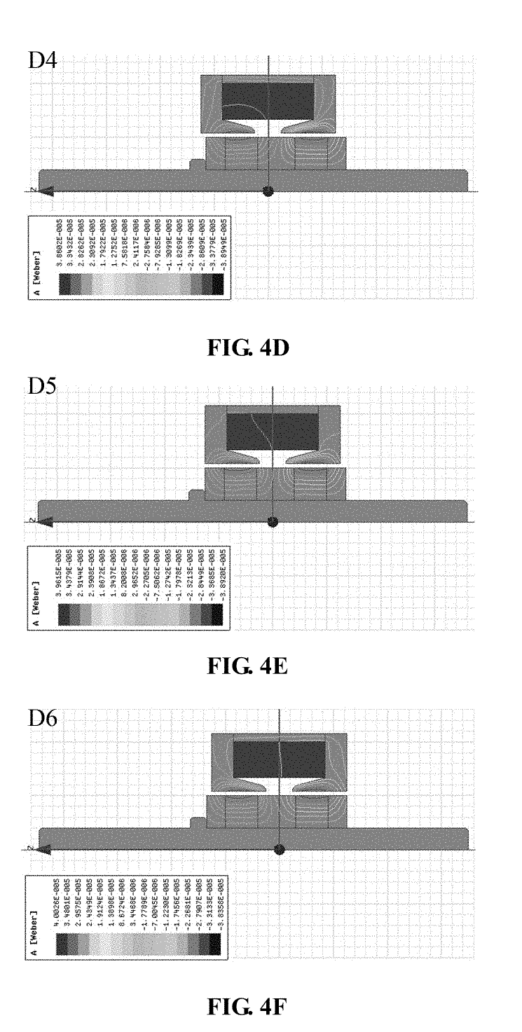

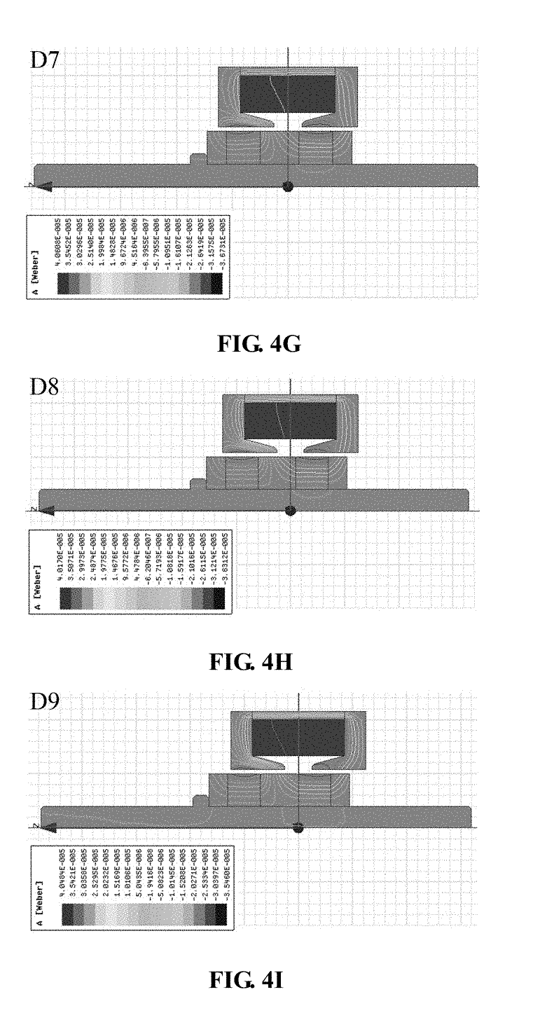

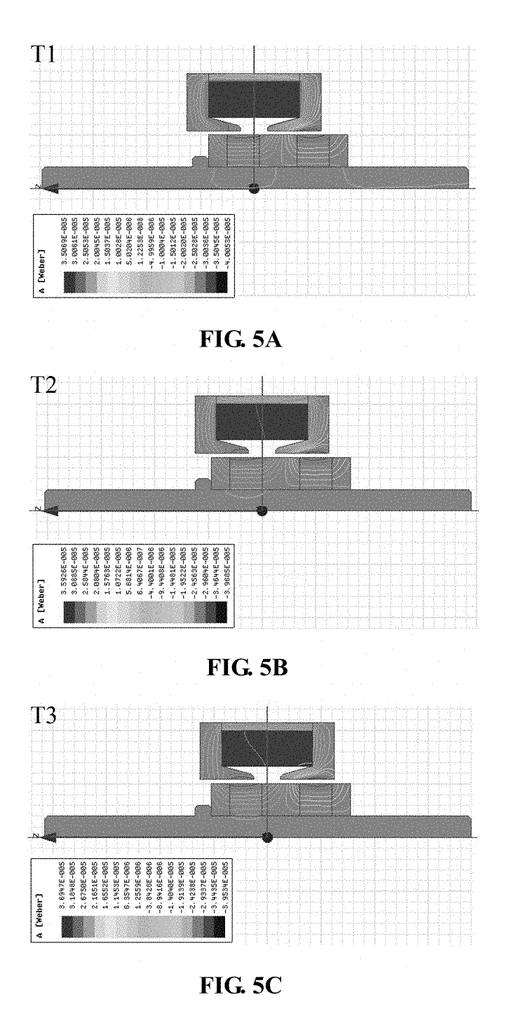

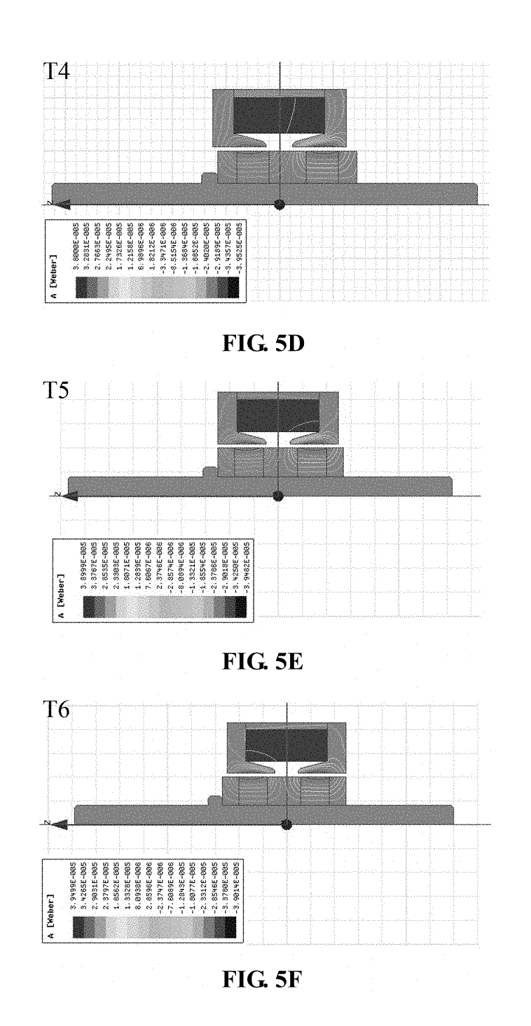

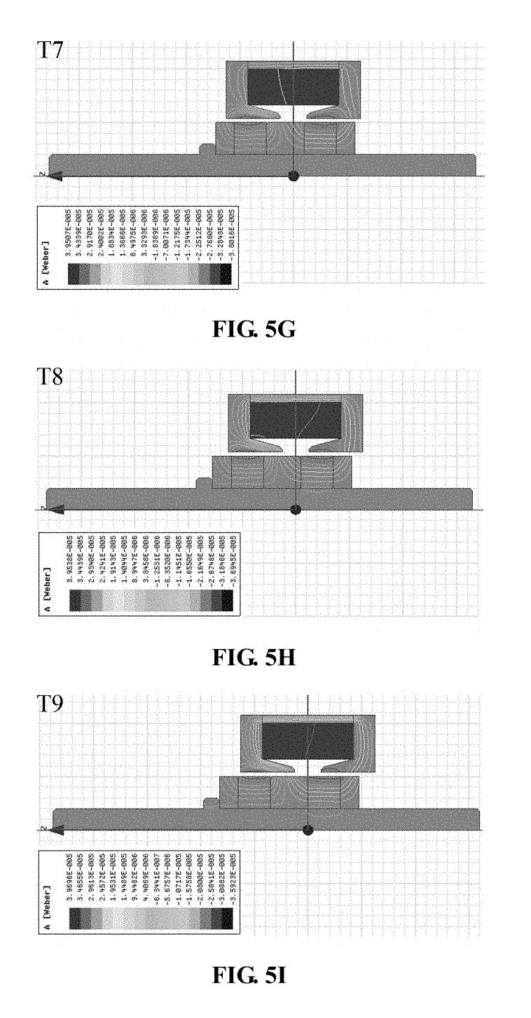

Referring now to FIGS. 3, 4A to 4I, and 5A to 5I, in which FIGS. 4A to 4I illustrate the variations in intensity of the magnetic field of the electromagnetic driving force at positions D1 to D9 in FIG. 3, when the current is applied to the electromagnetic driving module by a preferred embodiment of the present invention. FIGS. 5A to 5I illustrate the variations in intensity of the magnetic field of the cogging torque at respective positions, that is the magnetic field intensity at positions T1 to T9 in FIG. 3, when the current is applied to the electromagnetic driving module k a preferred embodiment of the present invention.

In addition, the user can adjust the magnitude of the massage force, the length of the massage stroke, and the massage frequency (speed) by means of the adjustment module 9. The adjustment module 9 includes a knob device composed of a variable resistor, which may also be a touch screen, a physical button or user interfaces and electronic components of the equivalent. According to this embodiment, when the user operates on the adjustment module 9, the control module 6 may adjust the current input to the electromagnetic driving module 5, to adjust the magnitude of the electromagnetic driving force F1 and the length of the stroke. Alternatively, the adjustment module 9 can be configured to control the duration of the current supplied to the electromagnetic driving module 5 so as to adjust the length of the output stroke, and to control the cycle period and frequency of the current supplied to electromagnetic driving mode so as to adjust the cycle period and frequency of the output stroke. In the present embodiment, when the frequency of the current supplied to the electromagnetic driving module 5 is high, the operating frequency of the massage becomes higher, that is to say, the time for the massage to make a round becomes shorter, and thus the operation stroke becomes shorter. Furthermore, the time required to activate and deactivate the electromagnetic driving module 5 not only will affect the frequency (cycle) of the massage operation, but will also affect the operation stroke. This is because if it takes a shorter time to activate the electromagnetic driving module, the operation stroke tends to become shorter.

In this embodiment, the storage unit 60 can store a plurality of applications responsible for different massage modes, and the control module 6 can adjust the magnitude, frequency and duration of the current supplied to the electromagnetic driving module 5 according to each respective application, to thereby present different massage strengths, massage frequencies, and lengths of output shaft strokes under different modes. Moreover, during the operation of each respective mode, the application can also modify the magnitude, frequency, and duration of the current input to the electromagnetic driving module 5 in the process of time. That is to say, the massage strength, frequency and stroke of the output shaft can be continuously changed according to the progress of the massage stroke.

The control mode of the present invention can be achieved in various ways. For example, the duration and frequency of the current input to the electromagnetic driving module 5 may be controlled by using TRIAL' to change the conduction angle, or by using a power switch element in combination with a pulse width modulation module (PWM).

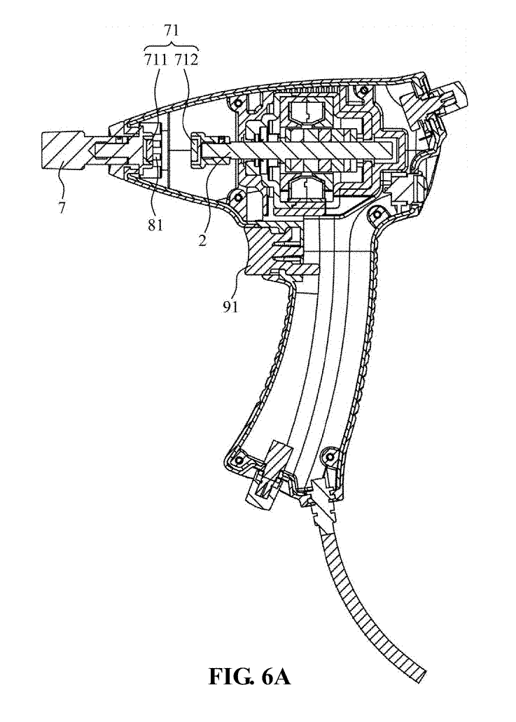

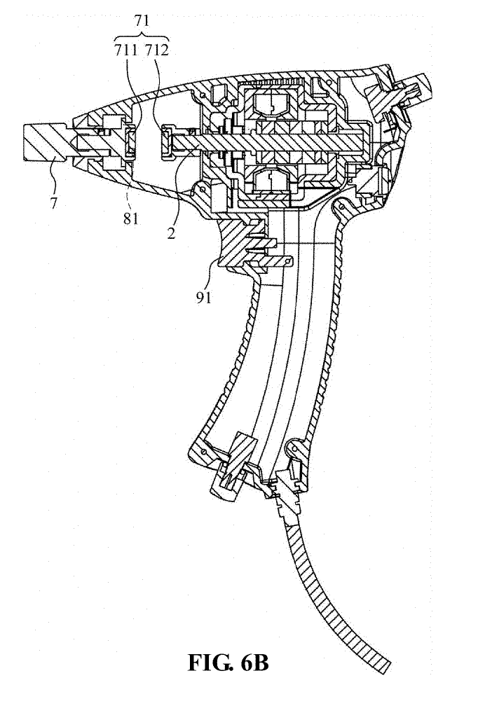

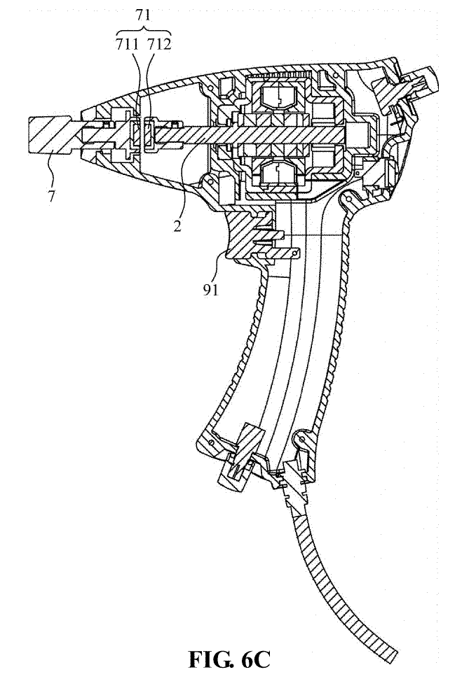

Referring now to FIGS. 6A, 6B and 6C, in which FIG. 6A is a cross-sectional view showing a further preferred embodiment of the present invention in an idle state; FIG. 6B is a cross-sectional view showing the massage head of the further preferred embodiment of the present invention after being pushed; and FIG. 6C is a cross-sectional view of the output shaft of the further preferred embodiment of the present invention after striking forcefully. This preferred embodiment as shown in the figures is different from the previous embodiment in that the massage head 7 of this embodiment further comprises an impact magnetic set 71 disposed between the massage head 7 and the output shaft 2. The impact magnetic set 71 includes two impact magnets 711, 712. One of the impact magnets 711 has one end arranged adjacent to one end of the other of the impact magnets 712, in which the two ends adjacent to each other have the same polarity. In other words, this embodiment generates repulsive force by designing the two adjacent impact magnets 711, 712 to have the same polarity in magnetic property. Moreover, this present embodiment further provides a detector 81 to detect the stroke position of the massage head 7. The number of magnets 3 of the present embodiment is preferably three.

As shown in FIG. 6A, when the massage device is in an idle state where power is not supplied, due to the repulsive force between the impact magnets 711; 712, the massage head 7 is pushed forward, and the output shaft 2 is pushed backward. That is to say, the output shaft 2 stops at the location where the resultant force of the cogging torque, the repulsive force between the impact magnets 711, 712, and the friction force is zero.

In addition, as shown in FIG. 6B, when the massage head 7 is pressed to urge backwards, that is, when the massage head 7 is pushed to abut the user's skin, the output shaft 2 will be pushed back correspondingly. When the massage head 7 retracts to a predetermined position, the detector 81 is triggered to effect firing (reciprocation) according to the setting of the application, or alternatively, the firing is initiated only when the user presses the start button 91. The application can be programmed to start firing when the start button 91 is persistently pressed, or to start firing continuously once the start button is pressed, and stop only when the start button is pressed again.

FIG. 6C is an illustration of the output shaft 2 upon firing/reciprocating. At this instant, the output shaft 2 is accelerated to strike outwards. As the massage head 7 is still in intimate contact with the human body, the distance between the impact magnets 711 and 712 becomes small instantaneously. Since at this time, the massage head 7 is subjected to a sudden burst of impact force, the instantaneous impact on the targeted point (trigger point) can be effectual.

Further, when in the idle state, the repulsive force between the two impact magnets 711, 712 causes the massage head 7 to urge forward, and the output shaft 2 to retreat, as shown in FIG. 6A. When the massage head 7 is pushed backward, the distance between the impact magnets 711 and 712 is shortened, and thus the repulsion between the impact magnets increases, as shown in FIG. 6B.

When the massage head 7 retracts to a predetermined position, the electromagnetic driving module 5 is energized to trigger the output shaft 2 to strike forward, as shown in FIG. 6C. At this time, the distance between the impact magnets 711 and 712 is further shortened. Since the repulsive force between the two impact magnets 711, 712 is inversely proportional to the distance, the thrust of the output shaft 2 acting on the massage head 7 varies tremendously at that instant. The massage head can then provide effective treatment on muscle and bone by providing instantaneous impact. The device does not need a spring to achieve the function, and will not result in discomfort due to direct impact of the output shaft 2 on the massage head 7.

The preferred embodiments of the present invention are illustrative only, and are not limited to the details disclosed in the drawings and the specification. Various changes can be made by those having ordinary skill in the art without departing from the equivalent changes and modifications made by the claims of the present invention, and should belong to the scope of the prevent invention.

What I claimed is:

1. A massage device comprising:
an output shaft;
a plurality of permanent magnets disposed on the output shaft, and generating a radial magnetic field on a partial region of the output shaft; and
an electromagnetic driving module comprising at least one stator yoke and at least one coil, the electromagnetic driving module being disposed radially outside the plurality of permanent magnets;
wherein the at least one stator yoke of the electromagnetic driving module is configured to interact with the plurality of permanent magnets of the output shaft to generate a cogging torque; the at least one coil of the electromagnetic driving module is driven by a current to generate an electromagnetic field, and is configured to interact with the radial magnetic field of the plurality of permanent magnets to generate an electromagnetic driving force.

2. The massage device according to claim 1, wherein the cogging torque applies a first thrust to the output shaft before an intermediate point of an output stroke, and the cogging torque starts to reverse after the intermediate point of the output stroke, and applies a first pulling force to the output shaft.

3. The massage device according to claim 2, wherein when the at least one coil of the electromagnetic driving module is driven by the current, the output shaft is actuated to strike forward in an axial direction; the cogging torque applies the first pulling force to the output shaft after the intermediate point of the output stroke; when the current supply is interrupted, the cogging torque returns the output shaft to a rest position, and when the output shaft is urged to move in the direction opposite to the strike forward direction to pass the rest position, the cogging torque applies a first thrust to the output shaft.

4. The massage device according to claim 1, further comprising at least one magnetically permeable member disposed on the output shaft for guiding the magnetic field of the magnet to become a radial magnetic field.

5. The massage device according to claim 1, further comprising a control module electrically connected to the electromagnetic driving module, the control module being configured to adjust the frequency of the electromagnetic driving force by controlling the frequency of the current input to the electromagnetic driving module; to adjust the magnitude of the electromagnetic driving force by controlling the magnitude of the current input to the electromagnetic driving module; and to adjust the length of the output stroke by controlling the duration of the current input to the electromagnetic driving module.

6. The massage device according to claim 5, further comprising an adjustment module electrically connected to the control module, the adjustment module being configured to adjust at least one of the magnitude, frequency and duration of the current input to the electromagnetic driving module.

7. The massage device according to claim 5, further comprising at least one position detector electrically connected to the control module, and adapted to detect the position of the output shaft.

8. The massage device according to claim 1, wherein the electromagnetic driving module further comprising at least one annular coil holder around which the at least one coil electrically connected to the control module is wound, the at least one coil holder includes a central through hole through which the output shaft extends.

9. The massage device according to claim 1, further comprising a massage head corresponding to one end of the output shaft, and an impact magnetic set disposed between the massage head and the output shaft; the impact magnetic set includes a pair of separated impact magnets arranged adjacent to each other, in which the opposing ends of the pair of separated impact magnets have the same polarity.

10. The massage device according to claim 1, wherein the control module includes a storage unit configured to store at least one application, the control module adjusts at least one of the magnitude, frequency and duration of the current input to the electromagnetic driving module based on the at least one application.
